(19) United States
(12) Patent Application Publication
(10) Pub. No.: US 2025/0197148 A1
(43) Pub. Date: Jun. 19, 2025

(54) Methods And Systems For Controlling Winding Machines

(71) Applicant: Siemens Aktiengesellschaft, München (DE)

(72) Inventors: Niklas Körwer, Köln (DE); Martin Bischoff, Aying (DE); Thomas Menzel, Langensendelbach OT Bräuningshof (DE)

(73) Assignee: Siemens Aktiengesellschaft, München (DE)

(21) Appl. No.: 18/979,855

(22) Filed: Dec. 13, 2024

(30) Foreign Application Priority Data
Dec. 14, 2023 (EP) 23216587.8

(51) Int. Cl. B65H 18/10; B65H 23/04; B65H 23/18; G06N 3/092

(52) U.S. Cl. CPC B65H 18/103; B65H 23/042; B65H 23/1806; G06N 3/092; B65H 2511/112; B65H 2513/11; B65H 2557/38

(57) ABSTRACT

Various embodiments of the teachings herein include a device for controlling a machine for winding a material onto a target, the machine including a storage for the material and a buffer system for buffering the winding material between the storage device and the target. An example includes: a communication port to receive a number of status signals, each of the status signals including a certain indication for a current process status of a material flow of the material; a processor using a neural network to provide a number of output signals to control the storage and/or the buffer system using the received status signals as input; and a controller to control the storage and/or the buffer system using the provided output signals.

### CROSS-REFERENCE TO RELATED APPLICATIONS

This application claims priority to EP Application Serial No. 23216587.8 filed Dec. 14, 2023, the contents of which are hereby incorporated by reference in their entirety.

### TECHNICAL FIELD

The present disclosure relates to winding machines. Various embodiments of the teachings herein include systems and/or methods for winding a winding material onto a target device.

### BACKGROUND

In winding/unwinding applications, material stored on a roll, the winding material, is wound/unwound to a target device and fed into/consumed from a discontinuous process. Examples for the winding material include plastic films, thin sheet metal, packaging labels, paper, battery separator films and the like.

To avoid having to accelerate and decelerate the entire material roll for every process step, a dancer arrangement of smaller rollers is used over which the winding material is run. Some rolls of this dancer arrangement are free to move which allows the coupling of a continuous rolling/unrolling of the winding material with the discontinuous process. If the dancer arrangement has a motor attached to some of the rollers, it is referred to as an active dancer arrangement. If the rollers are, instead, attached to a spring to provide tension, it is a passive dancer arrangement.

The amount of winding material that can be fed into the dancer arrangement is limited so some form of control is necessary for the film reel to account for sudden changes in the process speed or that of previous processes and for quickly stopping and restarting of the winding machine. Without any additional control, the tension of the material could either be too low which leads to problems in the process or be increased to a point where the material is deformed or destroyed. In both cases, the winding machine must be halted, and the material must be corrected by an operator. In many cases, this control is further complicated by the fact that the diameter of the material on the roll is unknown or measured with a large uncertainty, e.g. through an ultrasound sensor.

There are several conventional solutions using general control theory and motion control techniques to solve this problem. One example for a wide selection of applications is SINAMICS DCC (available under: https://support.industry.siemens.com/cs/document/38043750/). This document contains solutions for basic unwinding and winding applications but also includes a section dedicated to unwinding with a dancer arrangement. Like many other applications from other vendors, a series of PID controllers is used to control the amount of material that is unwound. Tuning these PID controllers requires a deep knowledge of control theory and the machine parameters. For many customers, this knowledge is concentrated in one machine operator that tunes these parameters by feel rather than rules and by trial and error. Uncertainties in the diameter complicate the search for optimized parameters. These conventional solutions are also limited to only directly controlling the unwinding with respect to the dancer position. Other process values like the machine speed of a previous machine or the material inflow can usually not be regarded.

### SUMMARY

Teachings of the present disclosure may be employed to enhance the control of a winding machine. For example, some embodiments of the teachings include a computer-implemented device (100) for controlling a winding machine (200) for winding a winding material (M) onto a target device (T5), the winding machine (200) including a storage device (210) for storing the winding material (M) and a buffer system (220) for buffering the winding material (M) between the storage device (210) and the target device (T5), the computer-implemented device (100) comprising: a receiving unit (110) for receiving a number N of status signals (S1-S11), each of the N status signals (S1-S11) including a certain indication for a current process status of a material flow of the winding material (M), a calculating unit (120) using at least one neural network (121), said at least one neural network (121) being configured to provide a number of output signals (O1, O2) for controlling the storage device (210) and/or the buffer system (220) using the received N status signals (S1-S11) as input, and a controlling unit (130) for controlling the storage device (210) and/or the buffer system (220) using the provided output signals (01, 02).

In some embodiments, the receiving unit (110) is configured to receive a plurality of N status signals (S1-S11) including: a current reel velocity (S1) of a roll of the storage device (210), said roll storing the winding material (M), a current speed (S2) of a motor of the storage device (210), a current speed (S3) of a motor of the buffer system (220), a current amount (S4) of the winding material (M) stored on the roll of the storage device (210), a current amount (S5) of the winding material (M) being buffered in the buffer system (220), a number of light bridge signals (S6) of light bridges arranged at an infeed belt (230) for providing incoming target devices (T1-T4), a number of position signals (S7) of light bridges arranged at the infeed belt (230) for providing the incoming target devices (T1-T4), a current speed (S8) of the infeed belt (230), a number of light bridge signals (S9) of light bridges arranged at an outfeed belt (240) for delivering outgoing target devices (T6-T9), a current speed (S10) of the outfeed belt (240), and/or a process signal (S11) indicating a current status of the process progress.

In some embodiments, the output signals (01, 02) provided by the neural network (121) include first setpoints (01) for a first motor controller for the motor of the storage device (210) and/or second setpoints (02) for a second motor controller for the motor of the buffer system (220).

In some embodiments, the neural network (121) is configured to use reinforcement learning and to receive as additional inputs rewards for a smooth movement of the winding material (M), the smooth movement being defined by an upper threshold for an acceleration of the winding material (M) in the winding machine (200), penalties for movements of the winding material (M) having an acceleration being higher than the upper threshold, and/or penalties for boundary violations.

In some embodiments, the computer-implemented device (100) is configured to control the winding machine (200) in a discontinuous process according to a discontinuous wrapping process in which the winding machine (200) wraps a plurality of target devices (T1-T9) using the winding material (M).

In some embodiments, the neural network (121) is trained using a Proximal Policy Optimization, PPO, algorithm, wherein in the PPO algorithm, a first neural network and a second neural network are trained, wherein the first neural network is configured to provide actions fed into the winding machine (200) and the second neural network is trained to estimate quality of these actions.

In some embodiments, the PPO algorithm is run on a simulation of the winding machine (200).

In some embodiments, the at least one neural network (121) of the calculating unit (120) has a Multi-Layer-Perception, MLP, structure or is a Long-Short-Term-Memory, LSTM, neural network or a Recurrent Neural Network, RNN.

As another example, some embodiments include a system (10) comprising a winding machine (200) for winding a winding material (M) onto a target device (T5), the winding machine (200) including a storage device (210) for storing the winding material (M) and a buffer system (220) for buffering the winding material (M) between the storage device (210) and the target device (T5), and a computer-implemented device (100) for controlling the winding machine (200) as described herein.

In some embodiments, the buffer system (220) is embodied as a dancer arrangement including a plurality of dancer rollers (221).

In some embodiments, at least one of the pluralities of dancer rollers (221) is an active dancer roller being driven by a dancer motor.

As another example, some embodiments include a computer-implemented method for controlling a winding machine (220) for winding a winding material (M) onto a target device (T5), the winding machine (200) including a storage device (210) for storing the winding material (M) and a buffer system (220) for buffering the winding material (M) between the storage device (210) and the target device (T5), the computer-implemented method comprising: receiving (301) a number N of status signals (S1-S11), each of the N status signals (S1-S11) including a certain indication for a current process status of a material flow of the winding material (M), feeding (302) the received N status signals (S1-S11) into at least one neural network (121) for providing a number of output signals (O1, O2) to control the storage device (210) and/or the buffer system (220), and controlling (303) the storage device (210) and/or the buffer system (220) using the provided output signals (O1, O2).

As another example, some embodiments include a computer program product comprising a program code for executing one or more of the computer-implemented methods described herein when run on at least one computer.

### BRIEF DESCRIPTION OF THE DRAWINGS

Further embodiments, features, and advantages of the teachings of the present disclosure are apparent from the subsequent description and dependent claims, taken in conjunction with the accompanying drawings, in which:

FIG. 1 shows a schematic block diagram of an example computer-implemented device for controlling a winding machine incorporating teachings of the present disclosure;

FIG. 2 shows a schematic block diagram of an example system including a winding machine and a computer-implemented device for controlling the winding machine incorporating teachings of the present disclosure; and

FIG. 3 shows a schematic flow chart of an example computer-implemented method for controlling a winding machine incorporating teachings of the present disclosure.

In the Figures, like reference numerals designate like or functionally equivalent elements, unless otherwise indicated.

### DETAILED DESCRIPTION

As an example, some embodiments of the teachings herein include a computer-implemented device for controlling a winding machine for winding a winding material onto a target device is proposed, the winding machine including a storage device for storing the winding material and a buffer system for buffering the winding material between the storage device and the target device. An example computer-implemented device comprises: a receiving unit for receiving a number N of status signals, each of the N status signals including a certain indication for a current process status of a material flow of the winding material, with N≥1, a calculating unit using at least one neural network, said at least one neural network being configured to provide a number of output signals for controlling the storage device and/or the buffer system using the received N status signals as input, and a controlling unit for controlling the storage device and/or the buffer system using the provided output signals.

The present computer-implemented device using at least one neural network can produce a smoother control that is not relying on simply starting or stopping the storage device and/or the buffer system. This improves the energy efficiency of the winding machine and reduces the amount of stress on the mechanical parts of the winding machine. Further, it reduces the amount of stress on the winding material because starting and stopping may have the highest values on acceleration which brings the highest amounts of stress for the winding material, what is prevented here.

The present neural network used by the calculating unit embodies an algorithm for an AI (artificial intelligence) policy of the computer-implemented device that can be set up to also include various machine states or signals from previous/following winding machines. This enables the neural network and therefore the calculating unit to have more control in cases of fast changing conditions where the process speed is changing quickly.

The at least one neural network of the calculating unit is, when operating the winding machine, a trained neural network. In order to facilitate training, it may be beneficial to transform the input signals, i.e., the received status signals, to encode additional information or to limit negative effects of the signals, like discontinuities. For example, for the estimated amount of winding material in the buffer system, it may be helpful to only pass the maximum or minimum value of the last machine cycles instead of the oscillating current value or apply a suitable filter for the signals. Furthermore, binary signals may be encoded as saw-tooth functions, for example.

The term “winding” refers to winding applications and to unwinding applications. The neural network may be also referred to as artificial neural network.

In some embodiments, the receiving unit is configured to receive a plurality of N status signals including:
a current reel velocity of a roll of the storage device, said roll storing the winding material,
a current speed of a motor of the storage device,
a current speed of a motor of the buffer system,
a current amount of the winding material stored on the roll of the storage device,
a current amount of the winding material being buffered in the buffer system,
a number of light bridge signals of light bridges arranged at an infeed belt for providing incoming target devices,
a number of position signals of light bridges arranged at an infeed belt for providing incoming target devices,
a current speed of the infeed belt,
a number of light bridge signals of light bridges arranged at an outfeed belt for delivering outgoing target devices, and/or
a current speed of the outfeed belt.
a process signal indicating a current status of the process progress.

In some embodiments, additional further status signals may be used which are configured to describe the current status of the system including the winding machine, the buffer system and the storage device. In applications, also subgroups of said status signals may be used.

In some embodiments, the output signals provided by the neural network include first setpoints for a first motor controller for the motor of the storage device and/or second setpoints for a second motor controller for the motor of the buffer system.

In some embodiments, the system including the winding machine may have a plurality of different motors with different functions. In embodiments, for each of said motors of the winding machine, the neural network of the calculating unit may provide suitable output signals if it is trained accordingly.

In some embodiments, the neural network is configured to use reinforcement learning and to receive as additional inputs rewards for a smooth movement of the winding material, penalties for movements of the winding material having an acceleration being higher than the upper threshold, and/or penalties for border violations. In particular, the smooth movement is defined by an upper threshold for an acceleration of the winding material in the winding machine.

Using the reinforcement learning, the at least one neural network may be trained. The reinforcement learning may use rewards and penalties to optimize the functionality of the computer-implemented device when controlling the winding machine. In particular, if the movement of the winding material, executed by the winding machine, has an acceleration under said upper threshold, said movement is a smooth movement. In the other case, if the movement of the winding material in the winding machine 200 has an acceleration equal to or greater than said upper threshold for acceleration, the movement is not smooth movement and the neural network may receive a penalty for violating said upper threshold. Further, for reinforcement learning, the neural network may receive penalties for actions that violate any predefined boundaries.

In some embodiments, the computer-implemented device is configured to control the winding machine in a discontinuous process according to a discontinuous wrapping process in which the winding machine wraps a plurality of target devices using the winding material. The discontinuous process of the computer-implemented device may correspond to said discontinuous wrapping process of the winding machine.

In some embodiments, the neural network is trained using a Proximal Policy Optimization (PPO) algorithm. In the PPO algorithm, a first neural network and a second neural network may be trained, wherein the first neural network is configured to provide actions fed into the winding machine and the second neural network is trained to estimate quality of these actions, in other words how good these actions are.

In some embodiments, the PPO algorithm is run on a simulation of the winding machine. Thus, the PPO algorithm is not run on the winding machine directly, but instead on a simulation of said winding machine. This is beneficial as reinforcement learning algorithms start off with random actions that can cause damage or problems in the winding machine. By using a simulation, the simulation can simply be reset after a series of destructive actions and a negative reward is returned to the algorithm so that the algorithm can learn from the mistakes.

In some embodiments, the PPO algorithm is run on a simulation of the winding machine.

In some embodiments, the at least one neural network of the calculating unit has a Multi-Layer-Perception (MLP) structure.

In some embodiments, the at least one neural network is a Long-Short-Term-Memory (LSTM) neural network.

In some embodiments, the at least one neural network is a Recurrent Neural Network (RNN).

In some embodiments, the at least one neural network may be trained with a new policy. This can be done very quickly while adaptions to the conventional approach often require a very deep understanding of control theory and the application at hand. This makes it difficult to adapt the existing solutions to new dancer arrangements, e. g., five rolls instead of three rolls, different locations of the rolls or coupling some of the rolls in the dancer arrangement to each other, for example. With the AI based approach using the at least one neural network, these parameters can easily be adjusted, and the policy can be retrained in only a few days. This can be achieved through cloud computing with an easy-to-use interface for the machine engineer.

The algorithm, embodied by the at least one neural network, may also be used for design optimizations by running different trainings with changing machine configurations, e.g. the number of rolls in buffer, the size of the material roll, the maximum acceleration and deacceleration of the reel, the number and the quality of the sensors.

The respective unit, e.g., the calculating unit, may be implemented in hardware and/or in software. If said unit is implemented in hardware, it may be embodied as a device, e.g., as a computer or as a processor or as a part of a system, e.g., a computer system. If said unit is implemented in software it may be embodied as a computer program product, as a function, as a routine, as a program code or as an executable object.

A neural network or artificial neural network includes software code stored on a computer-readable storage medium and represents one or more networked artificial neurons or can simulate their function. The software code can also contain several software code components, which can, for example, have different functions. In particular, an artificial neural network can implement a non-linear model or a non-linear algorithm that maps an input, here the status signals, to an output, here the output signals. The input may be given by an input feature vector, or an input sequence and the output can contain, for example, an output category for a classification task, one or more determined values, e. g. setpoints for motor controllers or a predicted sequence.

In some embodiments, a system comprises a winding machine for winding a winding material onto a target device, the winding machine including a storage device for storing the winding material and a buffer system for buffering the winding material between the storage device and the target device, and a computer-implemented device for controlling the winding machine as described herein.

In some embodiments, the buffer system comprises a dancer arrangement including a plurality of dancer rollers.

In some embodiments, at least one of the pluralities of dancer rollers comprises an active dancer roller driven by a dancer motor.

Some embodiments include a computer-implemented method for controlling a winding machine for winding a winding material onto a target device, the winding machine including a storage device for storing the winding material and a buffer system for buffering the winding material between the storage device and the target device. An example computer-implemented method comprises: receiving a number N of status signals, each of the N status signals including a certain indication for a current process status of a material flow of the winding material, with N≥1, feeding the received N status signals into at least one neural network for providing a number of output signals to control the storage device and/or the buffer system, and controlling the storage device and/or the buffer system using the provided output signals.

As used herein, a computer-implemented method is a method which utilizes a computer, a computer network, or another programmable device, wherein one or multiple features are wholly or partially realized by means of a computer program.

In some embodiments, there is a computer program product comprising a program code for executing one or more of the computer-implemented method as described herein when run on at least one computer is proposed. A computer program product, such as a computer program means, may include a memory card, USB stick, CD-ROM, DVD or as a file which may be downloaded from a server in a network. For example, such a file may be provided by transferring the file comprising the computer program product from a wireless communication network.

Further possible implementations or alternative solutions of the invention also encompass combinations—that are not explicitly mentioned herein—of features described above or below with regard to the embodiments. The person skilled in the art may also add individual or isolated aspects and features to the most basic form of the teachings herein.

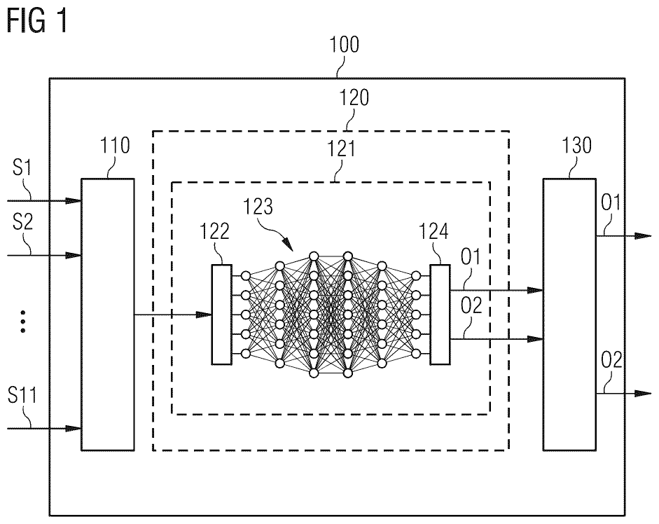

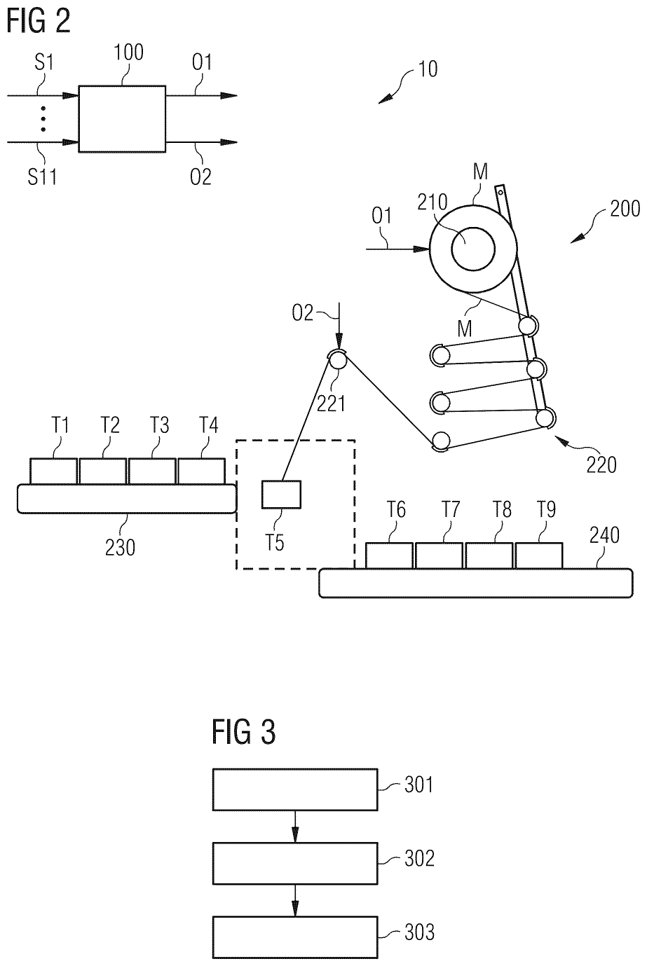

FIG. 1 depicts a schematic block diagram of an example computer-implemented device 100 for controlling a winding machine 200 incorporating teachings of the present disclosure. The computer-implemented device 100 of FIG. 1 is discussed with reference to FIG. 2, FIG. 2 showing a schematic block diagram of an example system 10 incorporating teachings of the present disclosure including a winding machine 200 and the computer-implemented device 100 of FIG. 1. It may be noted that FIG. 1 shows details of the computer-implemented device 100, wherein FIG. 2 shows the same computer-implemented device 100 in an abstracted manner to ensure readability of FIG. 2.

The system 10 includes a winding machine 200 for winding a winding material M onto a target device T5. As depicted in FIG. 2, the system 10 includes an infeed belt 230 for providing incoming target devices T1-T4 and an outfeed belt 240 for delivering output target devices T6-T9. As shown in FIG. 2, there are nine target devices T1-T9, wherein the target device T5 is under processing by the winding machine 200, the target devices T1-T4 are incoming target devices provided by the infeed belt 230 and the target devices T6-T9 are already processed by the winding machine 200 and therefore said target devices T6-T9 are on the outfeed belt 240.

The winding machine 200 includes a storage device 210 for storing the winding material M and a buffer system 220 for buffering the winding material M between the storage device 210 and the target device T5 under processing. The storage device 210 includes a roll storing said winding material M. For example, the winding material M may include a plastic film, a thin sheet metal, a paper, or a battery separator film. The winding machine 200 wraps the winding material M onto said target devices T1-T9 provided by the infeed belt 230 in a discontinuous process. The buffer system 220 is configured to buffer the winding material M between said storage device 210 and the target device T5 under processing.

For example, the buffer system 220 may include a dancer arrangement including a plurality of dancer rollers. In the example of FIG. 2, the dancer arrangement 220 includes seven dancer rollers. For sake of readability, only one of the dancer rollers is provided with the reference sign 221 in FIG. 2. Moreover, at least one of the pluralities of dancer rollers of the dancer arrangement 220 may be embodied as an active dancer roller being driven by a dancer motor. For example, the dancer roller with the reference sign 221 is an active dancer roller being driven by a dancer motor and may be controlled by a motor controller.

As FIG. 1 highlights, the computer-implemented device 100 includes a receiving unit 110, a calculating unit 120 and a controlling unit 130. The receiving unit 110 is configured to receive a number N of status signals S1-S11. In the embodiment of FIGS. 1 and 2, the receiving unit 110 receives eleven status signals S1-S11 without loss of generality. In general, N is equal to or greater than 1 (N≥1). Each of the N status signals S1-S11 includes a certain indication or information for the current process status of the material flow of the winding material M in the winding machine 200.

For example, the plurality of N status signals S1-S11 may include:
a current reel velocity S1 of a roll of the storage device 210, said roll storing the winding material M,
a current speed S2 of a motor of the storage device 210,
a current speed S3 of a motor of the buffer system 220,
a current amount S4 of the winding material M stored on the roll of the storage device 210,
a current amount S5 of the winding material M being buffered in the buffer system 220,
a number of light bridge signals S6 of light bridges arranged at an infeed belt 230 for providing incoming target devices T1-T4,
a number of position signals S7 of light bridges arranged at the infeed belt 230 for providing the incoming target devices T1-T4,
a current speed S8 of the infeed belt 230,
a number of light bridge signals S9 of light bridges arranged at an outfeed belt 240 for delivering outgoing target devices T6-T9,
a current speed S10 of the outfeed belt, and/or
a process signal S11 indicating a current status of the process progress.

The calculating unit 120 uses at least one neural network 121. Without loss of generality, the calculating unit 120 of FIG. 1 uses one neural network 121. For example, the neural network 121 of the calculating unit 120 has a multi-layer-perception (MLP) structure. In embodiments, the neural network 121 may include a Long-Short-Term-Memory (LSTM) neural network or as a Recurrent Neural Network (RNN).

The neural network 121 is configured to provide a number of output signals O1, O2 for controlling the storage device 210 and/or the buffer system 220 using the received N status signals S1-S11 as input. As illustrated in FIG. 1, the neural network 121 includes an input layer 122, a plurality of hidden layers 123 and an output layer 124. The input layer 122 of the neural network 121 receives the provided status signals S1-S11 from the receiving unit 110, processes these input status signals S1-S11 by means of the plurality of hidden layers 123 and provides the output signals O1, O2 to the controlling unit 130 via its output layer 124.

The controlling unit 130 is configured to control the storage device 210 and/or the buffer system 220 using the provided output signals O1, O2.

In some embodiments, the output signals O1, O2 as provided by the neural network 121 are adapted to control both the storage device 210 and the buffer system 220. In particular for the above discussed case that the buffer system 220 is embodied as a dancer arrangement including at least one active dancer roller, the neural network 121 may provide output signals O1, O2 for controlling both the storage device 210 and the dancer arrangement.

For example, the output signals O1, O2 provided by the neural network 121 include first setpoints O1 for a first motor controller for at least one motor of the storage device 210 and second setpoints O2 for a second motor controller for at least one motor of the buffer system 220. In the example of FIG. 2, the output signal O1 is adapted to control the first motor controller for the at least one motor of the storage device 210 and the output signal O2 is adapted to control the second motor controller for the at least one dancer motor of the dancer roller 221.

In some embodiments, the neural network 121 is configured to use reinforcement learning. In this case, the neural network 121 is adapted to receive as additional inputs rewards for a smooth movement of the winding material M, the smooth movement being defined by an upper threshold for an acceleration of the winding material M in the winding machine 200. In other words, if the movement of the winding material M, executed by the winding machine 200, has an acceleration under said upper threshold, said movement is a smooth movement. In the other case, if the movement of the winding material M in the winding machine 200 has an acceleration equal to or greater than said upper threshold for acceleration, the movement is no smooth movement and the neural network 121 may receive a penalty for violating said upper threshold. Furthermore, for reinforcement learning, the neural network 121 may receive penalties for actions that violate any predefined boundaries.

As discussed above, the winding machine 200 particularly wraps said plurality of target devices T1-T9 with the winding material M in a discontinuous wrapping process. In this regard, the computer-implemented device 100 is particularly configured to control the winding machine 200 in a discontinuous process, too. The discontinuous process of the computer-implemented device 100 may correspond to said discontinuous wrapping process of the winding machine 200.

Before operation, the neural network 121 is trained. For training, a Proximal Policy Optimization (PPO) algorithm may be used. In the PPO algorithm, a first neural network and a second neural network may be trained, the first neural network being configured to provide actions fed into the winding machine 200 and the second neural network may be trained to estimate the quality of these actions, in other words how good these actions are.

In some embodiments, the PPO algorithm is run on a simulation of the winding machine 200. In other words, the PPO algorithm is not run on the winding machine 200 directly, but instead on a simulation of said winding machine 200. This is beneficial as reinforcement learning algorithms start off with random actions that can cause damage or problems in the winding machine 200. By using a simulation, the simulation can simply be reset after a series of destructive actions and a negative reward is returned to the algorithm so that the algorithm can learn from the mistakes.

Furthermore, FIG. 3 shows a schematic flow chart of an example computer-implemented method incorporating teachings of the present disclosure for controlling a winding machine 200. An example of such a winding machine 200 is depicted in FIG. 2. The winding machine 200 is configured for winding a winding material M onto a target device T5, said winding machine 200 includes a storage device 210 for storing the winding material M and a buffer system 220 for buffering the winding material M between the storage device 210 and the target device T5.

The computer-implemented method of FIG. 3 includes elements 301-303:

In step 301, a number of status signals S1-S11 is received. Each of the N status signals S1-S11 includes a certain indication for the current process status of the material flow of the winding material M.

In step 302, the received N status signal S1-S11 are fed into at least one neural network 121 for providing a number of output signals O1, O2 to control the storage device 210 and/or the buffer system 220.

In step 303, the storage device 210 and/or the buffer system 220 is controlled using the provided output signals O1, O2. It may be noted that the computer-implemented device 100 of FIG. 1 and FIG. 2 may be adapted to execute above method steps 301-303.

Although the present disclosure has been described using example embodiments, it is obvious for the person skilled in the art that modifications are possible to all of these: embodiments. Independent of the grammatical term usage, individuals with male, female or other gender identities are included within the term.

### REFERENCE NUMERALS

10 system
100 computer-implemented device
110 receiving unit
120 calculating unit
121 neural network
122 input layer
123 hidden layer
124 output layer
130 controlling unit
200 winding machine
210 storage device
220 buffer system
221 dancer roller
230 infeed belt
240 outfeed belt
301-303 method steps
M winding material
O1-O2 output signal
S1-S11 status signal
T1-T9 target device

1. A device for controlling a machine for winding a material onto a target, the machine including a storage for the material and a buffer system for buffering the winding material between the storage device and the target, the device comprising:
a communication port to receive a number of status signals, each of the status signals including a certain indication for a current process status of a material flow of the material;
a processor using a neural network to provide a number of output signals to control the storage and/or the buffer system using the received status signals as input; and
a controller to control the storage and/or the buffer system using the provided output signals.

2. The device of claim 1, wherein the status signals include one or more of:
a current reel velocity of a roll of the storage, said roll storing the material;
a current speed of a motor of the storage;
a current speed of a motor of the buffer system;
a current amount of the material stored on the roll;
a current amount of the material in the buffer system;
a number of light signals from light bridges arranged at an infeed belt to provide incoming target devices;
a number of position signals from the light bridges;
a current speed of the infeed belt;
a number of light signals of light bridges arranged at an outfeed belt to deliver outgoing target devices;
a current speed of the outfeed belt; and/or
a process signal indicating a current status of progress.

3. The device of claim 1, wherein the output signals include first setpoints for a first motor controller for the motor of the storage and/or second setpoints for a second motor controller for the motor of the buffer system.

4. The device of claim 1, wherein:
the neural network uses reinforcement learning and receives as additional input rewards for a smooth movement of the winding material;
wherein smooth movement is defined by an upper threshold for an acceleration of the material in the winding machine, penalties for movements of the material having an acceleration higher than the upper threshold, and/or penalties for boundary violations.

5. The device of claim 1, wherein the controller is configured to control the winding machine according to a discontinuous wrapping process to wrap a plurality of target devices using the material.

6. The device of claim 1, wherein:
the neural network is trained using a Proximal Policy Optimization (PPO) algorithm;
the PPO algorithm trains a first neural subnetwork and a second neural subnetwork;
the first neural subnetwork provides actions fed into the winding machine and the second neural subnetwork is trained to estimate a quality of these actions.

7. The device of claim 6, wherein the PPO algorithm is run on a simulation of the winding machine.

8. The device of claim 1, wherein the neural network has a Multi-Layer-Perception (MLP) structure or is a Long-Short-Term-Memory (LSTM) neural network or a Recurrent Neural Network (RNN).

9. A system comprising:
a winding machine to wind a material onto a target
a storage to store the material;
a buffer system to buffer the material between the storage and the target; and a communication port to receive a number of status signals, each of the status signals including a certain indication for a current process status of a material flow of the material;
a processor using a neural network to provide a number of output signals to control the storage and/or the buffer system using the received status signals as input; and
a controller to control the storage and/or the buffer system using the provided output signals.

10. The system of claim 9, wherein the buffer system includes a dancer arrangement with a plurality of dancer rollers.

11. The system of claim 10, wherein at least one of the plurality of dancer rollers comprises an active dancer roller driven by a dancer motor.

12. A method for controlling a winding machine for winding a material onto a target, the winding machine including a storage to store the winding material and a buffer system to buffer the material between the storage and the target, the method comprising:
receiving a number of status signals, each of the status signals including a certain indication for a current process status of a material flow of the material;
feeding the received status signals into a neural network to provide a number of output signals to control the storage (210) and/or the buffer system; and
controlling the storage and/or the buffer system using the provided output signals.
